(19) United States
(12) Patent Application Publication
(10) Pub. No.: US 2008/0014438 A1
(43) Pub. Date: Jan. 17, 2008

(54) Rubber Composition, Elastomer, Method for Producing the Same and Use of Composite Particles

(75) Inventors: Thomas Ruhle, Weinheim (DE); Dirk Schubert, Leutershausen (DE); Achim Gruber, Schonau (DE); Gregor Grun, Weinheim (DE); Jurgen Henke, Viernheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/597,948

(22) PCT Filed: May 6, 2005
(86) PCT No.: PCT/EP05/04933

§ 371 Date: Nov. 28, 2006

(30) Foreign Application Priority Data
May 28, 2004 (DE) 10 2004 026 685.9

(51) Int. Cl. C08K 9/12; C08K 9/02; C08K 9/04

(52) U.S. Cl. 428/336; 428/339; 524/1; 524/588; 524/592; 524/599; 524/609; 524/612

(57) ABSTRACT

A composition including a) rubber, b) crosslinking agent, c) metals and/or chalcogenides of metals as crosslinking aids and/or antiaging agents is described, wherein at least one of components b) or c) is in the form of composite particles composed of carrier particles to whose surface particles of the active material having an average diameter of less than 25 μm are applied and layers thereof having an average layer thickness of less than 25 μm and/or conglomerates of multiple carrier particles to whose surface particles of active material having an average diameter of less than 25 μm are applied or layers thereof having an average layer thickness of less than 25 μm and d) optionally other conventional additives. The composite particles make it possible to lower the active material content while achieving comparable properties or improving the aging resistance of elastomers and/or increasing productivity.

### BACKGROUND

The present invention relates to rubber compositions containing selected composite particles, elastomers obtainable therefrom, and a method for producing same. Furthermore, use of selected composite particles as crosslinking agents and/or as crosslinking aids and/or for use as antiaging agents for elastomers is described.

When using ultrafine particles in rubbers, the optimal distribution of particles is very important to be able to utilize their potential as well as possible. This goal is achievable only in exceptional cases by inputting mechanical energy.

There are known methods from the field of heterogeneous catalysis for producing ultrafine particles on ceramic and carbon-based substrates. As described by C. Prado-Burguete et al. in Journal of Catalysis 128 (1991), 397-404, for example, depending on the selected preparation and reaction conditions, ultrafine platinum particles having a diameter of 1 nm to 10 nm are obtainable on the surface by impregnating carbon blacks with hexachloroplatinic acid and then oxidizing with oxygen and reducing with hydrogen. Any prior activation of the substrates here is usually performed under a specific gas atmosphere at elevated temperatures.

U.S. Pat. No. 6,146,454 describes a method for producing precipitated silicas which may be used as fillers to improve the Theological properties of elastomers. Precipitated silicas have a zinc content of 1 to 5% by weight, are in spherical form, and are characterized by a number of other physical parameters. Spherical silica gels having average diameters of more than 80 μm are used as fillers. No details about the location of the zinc in these particles are given in this patent.

EP-A-475,046 describes a method for producing particles in which zinc oxide and silica are pressed together. The resulting particles have diameters in the micrometer range. They do not contain any nano-scale components. These fillers do not form dust and are conveyed well, are processable in the usual mixing equipment, and are readily dispersible in rubber compounds.

WO-A-03/97,735 describes inorganic fillers coated with nano-scale Sn compounds. These fillers are suitable as flame retardants in polymer compositions, including elastomers.

WO-A-00/15,710 describes surface-modified fillers for flame-retardant finishing of polymers, including elastomers. Because of the method used to produce the fillers described here, it may be assumed that the modification is in the form of a coating on the surface.

WO-A-01/14480 describes coating the surface of nanoparticulate silicas with a combination of coupling reagent and an organometal hydrophobizing component. The coated silicas are used as fillers for elastomers. Because of the described method for producing the fillers, it may also be assumed here that the modification is in the form of a coating on the surface.

EP-A-631,982 describes silica additives that are proposed for use as fillers for reinforcing elastomers. No information is given about the morphology of the particles. However, based on the production method, it may be assumed that foreign ions are optionally incorporated into the volume phase of the silica during the precipitation.

Finally, U.S. Pat. No. 6,121,346 describes rubber compositions containing a filler having large nano-scale particles attached to its surface. The filler is dispersed well in rubber without agglomeration of the nano-scale particles. This additive should counteract wear on the tread.

DE 43 07 221 Al describes the use of supported p-dinitrosobenzene (DNB) in elastomer compositions.

U.S. Pat. No. 6,121,346 describes the use of fillers comprising large particles applied thereto in elastomer compositions. Use of supported antiaging agents and/or crosslinking aids cannot be derived from this publication.

GB-A-1,073,868 describes the production of a reinforcing agent for elastomer compositions. To do so, pellets are produced from an intimate mixture of carbon black and zinc oxide. Alternatively, an intimate mixture of carbon black and a precursor for zinc oxide may be used. The carbon black/zinc oxide combinations described in this publication are inhomogeneous and there is no information about the layer thickness or particle size of the zinc oxide.

### SUMMARY OF THE INVENTION

Against the background of this related art, an object of the present invention is to provide a rubber compound and an elastomer produced therefrom having a definitely reduced heavy metal content while exhibiting comparable mechanical properties.

Another object is to provide a rubber compound and an elastomer produced therefrom that will have a drastically improved aging behavior to yield a high mechanical quality level that cannot be achieved otherwise even with a definite increase in filler content when using traditional additives.

Another object has been to provide a method for producing this elastomer which is simple to carry out and yields reproducible results.

The present invention provides adding selected supported additives to the rubber composition, where these additives have comparatively small amounts of crosslinking agents and/or crosslinking aids and/or antiaging agents on the surface.

The present invention provides a composition containing a) rubber, b) crosslinking agent, optionally in the form of composite particles, composed of carrier particles to whose surface particles of a crosslinking agent having an average diameter of less than 25 μm are applied and/or conglomerates of several carrier particles to whose surface particles of crosslinking agent having an average diameter of less than 25 μm are applied, c) crosslinking aids and/or antiaging agents, namely a metal and/or a chalcogenide of a metal, optionally in the form of composite particles composed of carrier particles to whose surface particles of crosslinking aid and/or antiaging agent are applied, which is a metal and/or a chalcogenide of a metal, having an average diameter of less than 25 μm and/or conglomerates of several carrier particles to whose surface particles of crosslinking aid and/or antiaging agent are applied, which is a metal and/or a chalcogenide of a metal, having an average diameter of less than 25 μm, and optionally d) other conventional additives, with the provision that at least one of components b) or c) is in the form of composite particles.

In another embodiment, the present invention provides a composition containing a) rubber, b) crosslinking agent, optionally in the form of composite particles, composed of carrier particles to whose surface a layer of crosslinking agent having an average layer thickness of less than 25 μm is applied and/or composed of conglomerates of multiple carrier particles to whose surface a layer of crosslinking agent having an average layer thickness of less than 25 μm is applied, c) crosslinking aid and/or antiaging agent, which is a metal and/or a chalcogenide of a metal and is optionally in the form of composite particles, composed of carrier particles to whose surface a layer of crosslinking aid and/or antiaging agent is applied, which is a metal and/or a chalcogenide of a metal, having an average layer thickness of less than 25 μm and/or conglomerates of multiple carrier particles to whose surface a layer of crosslinking aid and/or antiaging agent is applied, which is a metal and/or a chalcogenide of a metal, having an average layer thickness of less than 25 μm, and optionally d) additional customary additives, with the provision that at least one of components b) or c) is in the form of composite particles.

Another preferred embodiment of the present invention provides compositions containing components a), b), c) and optionally d) as defined above, where components b) and c) are in the form of composite particles and component b) is composed of carrier particles to whose surface a layer of crosslinking agent having an average layer thickness of less than 25 μm is applied and/or composed of conglomerates of multiple carrier particles to whose surface a layer of crosslinking agent having an average layer thickness of less than 25 μm is applied, and component c) is composed of carrier particles to whose surface particles of crosslinking aid and/or antiaging agent are applied, which is a metal and/or a chalcogenide of a metal having an average diameter of less than 25 μm and/or composed of conglomerates of multiple carrier particles to whose surface particles of crosslinking aid and/or antiaging agent are applied, which is a metal and/or a chalcogenide of a metal, having an average diameter of less than 25 μm.

Another preferred embodiment of the present invention provides compositions containing components a), b), c) and optionally d) as defined above, where components b) and c) are in the form of composite particles and component c) is composed of the carrier particles to whose surface a layer of crosslinking aid and/or antiaging agent is applied, which is a metal and/or a chalcogenide of a metal, having a layer thickness of less than 25 μm, and/or composed of conglomerates of multiple carrier particles to whose surface a layer of crosslinking aid and/or antiaging agent is applied, which is a metal and/or a chalcogenide of a metal, having an average layer thickness of less 25 μm, and component b) is composed of carrier particles to whose surface particles of crosslinking agent having an average diameter of less than 25 μm are applied and/or composed of conglomerates of multiple carrier particles to whose surface particles of crosslinking agent having an average diameter of less than 25 μm are applied.

Another preferred embodiment of the present invention provides compositions containing components a), b), c) and optionally d) as defined above, where components b) and c) are present jointly on a composite particle composed of carrier particles to whose surface particles of crosslinking agent, crosslinking aid and/or antiaging agent are applied, each having an average diameter of less than 25 μm and/or composed of conglomerates of multiple carrier particles to whose surface particles of crosslinking agent, crosslinking aid and/or antiaging agent are applied, each having an average diameter of less 25 μm.

Crosslinking agents, crosslinking aids and antiaging agents are also referred to below as “active material.”

The present invention also provides a method for producing an elastomer from the rubber composition defined above, comprising the measures:
i) compounding components a), b), c) and optionally d) as defined above in a known way, and
ii) heating the composition containing components a), b), c) and optionally d) to a temperature and for a period of time to induce the crosslinking of component a).

Component a) used according to the present invention may be a rubber of any type.

### DETAILED DESCRIPTION

Within the context of the present description, a rubber may be understood to be a polymer that may be processed to yield an elastomer.

Within the scope of the present description, the term “elastomer” may be understood as being defined broadly as chemically or physically crosslinked polymers that have steel-like elasticity below their glass transition point and have rubber-like elasticity at temperatures above their glass transition point, i.e., they do not have viscous flow even at high temperatures. Typical glass transition temperatures of elastomers are 20° C. or lower. Elastomers produced according to the present invention preferably have rubber-like elastic properties up to their melting point or decomposition point and/or the T_{g} of the hard component in the case of thermoplastic elastomers.

The term “elastomer” may include not only thermoplastic elastomers but in particular elastomers that must be crosslinked in the course of processing.

The rubbers used here may include all known synthetic rubbers and natural rubbers. Typical and preferred rubbers include acrylate rubber, polyester urethane rubber, brominated butyl rubber, polybutadiene, chlorinated butyl rubber, chlorinated polyethylene, epichlorohydrin homopolymer, polychloroprene, sulfonated polyethylene, ethylene-acrylate rubber, ethylene-vinyl acetate rubber, epichlorohydrin copolymers, ethylene-propylene rubber (EP(D)M), sulfur-crosslinked or peroxide-crosslinked polyether-urethane rubber, ethylene-vinyl acetate copolymer, fluorine rubber (FKM), silicone rubbers, e.g., fluorosilicone rubbers or vinyl-containing dimethylpolysiloxane as well as hydrogenated nitrile rubber, butyl rubber, halobutyl rubber, polyoctenamer, polypentenamer, nitrile rubber, natural rubber, thioplasts, polyfluorophosphazenes, polynorbornenes, styrene-butadiene rubber, carboxyl group-containing nitrile rubber or blends of one or more of these rubbers.

In addition, thermoplastic elastomers may also be used. These include the known block copolymers (TPE-S, TPE-E, TPE-U, TPE-A) and elastomer alloys (e.g., TPE-V, TPE-O).

Component a) may be used in different forms, e.g., as granules or in another size-reduced form. Component a) may be a compact polymer or may be in the form of a foam or a liquid, dissolved or water-emulsified system.

All conventional types of crosslinking agents may be used as component b). They may be low-molecular or high-molecular compounds. Component b) may be used in a traditional makeup in the compositions according to the present invention. Component b) is preferably used in the form of the composite particles defined above. At least one of components b) or c) is in the form of composite particles. Composite particles jointly supporting components b) and c) may also be used.

Component b) is typically used in amounts of 0.1 phr to 150 phr based on the amount of crosslinking agent in the mixture according to the present invention, preferably in amounts of 2 phr to 20 phr.

Typical and also preferred crosslinking agents include sulfur, peroxides, bisphenol crosslinking systems, crosslinking resins such as polymethylolphenol resins or compounds that act as crosslinking accelerators. These include, for example, thiurams, guanidines, thiazoles, xanthogenates, dithiocarbamates, sulfenamides, dithiophosphates, triazine accelerators or quinone dioximes. Particularly preferred components b) are the bisthiocarbamoylsulfanes of the general formula

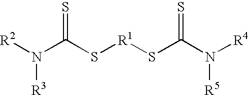

where R¹ denotes a covalent bond or a divalent organic radical, preferably an alkylene radical, and R², R³, R⁴ and R⁵, independently of one another, denote hydrogen or organic radicals, preferably alkyl or aryl radicals.

In a preferred embodiment, component b) is used in the form of composite particles composed of carrier particles to whose surface particles of a crosslinking agent having an average diameter of less than 25 μm are applied and/or composed of conglomerates of multiple carrier particles to whose surface particles of crosslinking agent having an average diameter of less than 25 μm are applied.

In another preferred embodiment, component b) is may be used in the form of composite particles composed of carrier particles to whose surface a layer of a crosslinking agent having an average layer thickness of less than 25 μm is applied and/or composed of conglomerates of multiple carrier particles to whose surface a layer of crosslinking agent having an average layer thickness of less than 25 μm is applied.

Any materials may be used as the carrier particles for the composite particles used according to the present invention. These materials may be in any form, e.g., round, ellipsoidal, irregular or in the form of fibers. However, these are delicate particles whose average diameter is less than 25 μm, preferably less than 10 μm, particularly preferably less than 5 μm and most particularly preferably 5 nm to 1 μm (determined by electron microscopy). In the case of using fibers, it is sufficient if they have a small diameter (median), e.g., of less than 50 μm in only one dimension.

In addition to using corpuscular or fibrous carrier particles, conglomerates of such particles may also be used. Conglomerates of carrier particles may assume various forms. These may be network-type structures, e.g., percolation networks of fibers as the carrier materials to whose surface of the individual carrier materials nano-scale particles or thin layers of crosslinking aids and/or antiaging agents are applied.

These are in particular conglomerates of carrier particles of different structures such as corpuscular and flaky carrier particles, in particular lamellar carrier particles.

The composite particles of component c) and/or component b) used according to the present invention may be modified by applying surface layers so that their tendency to agglomerate in the rubber and/or elastomer composition is reduced. However, it is important for the nanoparticulate particles applied to the surface and/or layers of crosslinking aids and/or antiaging agents and/or at least parts of the surface layers thereof to remain accessible for the rubber and/or the elastomer. Additional surface layers may be applied by polymerization, grafting and adsorption of surface-active polymers, these substances optionally being applied simultaneously with the crosslinking aid and/or antiaging agent and/or thereafter.

In a particularly preferred embodiment, the composite particles of component c) and/or component b) used according to the present invention are coated with a wax. The activity of the supported crosslinking aids, antiaging agents and/or crosslinking agents may therefore be adjusted in a targeted manner, allowing a defined start or a targeted reaction of the components used. Waxes whose melting points are in the range between 80° C. and 250° C., in particular in the range from 140° C. to 200° C., are preferred.

The carrier particles may be activated by chemical and/or physical methods prior to application and/or production of the superficially bound nano-scale particles and/or the thin surface layers, e.g., by thermal, chemical, or mechanical treatment methods such as tempering in a furnace, treatment with acids, or in the ball mill.

Component c) is typically present in amounts of 0.1 phr to 150 phr based on the amount of crosslinking aid and/or antiaging agent in the mixture according to the present invention, preferably in amounts of 2 phr to 20 phr.

Composite particles which are in the form of individual particles or conglomerates containing these particles are preferred for use as component b) or c); the individual particles are composed of carrier particles which are sheathed with a layer of oxidic material having an irregular surface to which particles of crosslinking agent and/or crosslinking aid and/or antiaging agent having an average diameter of less than 25 μm are applied.

Composite particles which are in the form of individual particles or conglomerates containing these individual particles are an additional preferred form for use of components b) and/or c); in this case the individual particles are composed of carrier particles sheathed with a layer of oxidic material having an irregular surface to which a layer of crosslinking agent or crosslinking aid and/or antiaging agent having an average layer thickness of less than 25 μm is applied.

Typical materials of which the carrier particles of component c) and/or component b) are composed include carbons or carbon compounds, e.g., carbon blacks, graphite or chemically modified graphite, as well as oxidic materials of synthetic or natural origin such as silicates, silicon dioxide, or metal oxides, e.g., aluminum oxide or other thermally and mechanically stable ceramic materials, e.g., silicon nitride, silicon carbide, or boron nitride or metal carbonates such as calcium carbonate or metal sulfides or sulfates such as calcium sulfate, barium sulfate, or iron sulfide. Delicate ceramic compositions or organic polymers may also be used as carrier particles. The latter are to be selected so that they survive the temperature treatments in production of the composite particles without any significant degradation or decomposition.

Conglomerates of carrier particles of various structures are preferred, particularly preferred in a corpuscular or flaky form, in particular a corpuscular and lamellar form, preferably corpuscular quartz and lamellar kaolinite.

The two mineral phases of the preferred conglomerate for use according to the present invention form a loose bulk material. Several advantages in terms of application technology are obtained from the combination of corpuscular and flaky structures. These conglomerates are therefore rapidly incorporated into the rubber matrix, resulting in virtually no filler pockets, a low tendency to sediment, and excellent dispersion properties; the conglomerates have a high surface activity, and the rubber composition has excellent extrusion properties.

Therefore, the present invention also relates to compositions containing as component b) and/or as component c) composite particles composed of conglomerates of several different carrier particles having a corpuscular and flaky form, in particular a lamellar form, and wherein particles of crosslinking aid and/or antiaging agent and/or crosslinking agent having an average diameter of less than 25 μm are applied to the surface of the different carrier particles.

In another embodiment, the present invention relates to compositions containing as component b) and/or as component c) composite particles composed of conglomerates of several different carrier particles having a corpuscular and flaky form and in which a layer of crosslinking aid and/or antiaging agent and/or crosslinking agent having an average layer thickness of less than 25 μm is applied to the surface of the different carrier particles.

In addition to components b) and/or c), the composite particles used according to the present invention may also contain other supported particles which are different from components b) and c) and are adsorbed onto the surface of the carrier particles or are otherwise attached there. In addition to the composite particles which are used according to the present invention and contain components b) and/or c), other composite particles containing particles or layers of components d) adsorbed or otherwise attached to the surface of the carrier particles may also be used.

The particles of crosslinking aid and/or antiaging agent and/or crosslinking agent may have any shape, e.g., round, ellipsoidal, or irregular. However, these are delicate particles having an average diameter of less than 25 μm, preferably less than 1 μm, determined by electron microscopy, particularly preferably from 0.01 μm to 0.5 μm. Or they may be thin surface layers having an average layer thickness of less than 25 μm, preferably less than 1 μm, determined by electron microscopy, particularly preferably from 0.01 μm to 0.5 μm. The particles and/or layers of crosslinking aid and/or antiaging agent and/or crosslinking agent in the composite particles used according to the present invention are considerably smaller than the particular carrier particles. The ratio of the average diameter of the particles of active material to the average diameter of the carrier particle typically amounts to less than 1:2, preferably 1:10 to 1:1000 and/or the ratio of the average layer thickness of the surface layer of active material to the average diameter of the carrier particle amounts to less than 1:2, preferably 1:10 to 1:1000.

It is assumed that the particles of crosslinking aid and/or antiaging agent and/or crosslinking agent are may be incorporated into the pores or depressions in the fissured surface of the conglomerates of various carrier materials, in such a way that they are freely accessible from the surroundings of the composite particle.

In the case of the thin surface layers, they may cover the entire surface or only a portion thereof.

As additional supported materials, any substances are usable with which the desired property of the elastomer composition may be influenced.

The additional supported material is typically a non-conducting or semiconducting substance and/or nonchalcogenide compounds of metals, in particular nitrides or carbides of metals and the other materials listed below for component d).

The metals and/or metal chalcogenides of component c) may be used in a traditional make-up in the compositions according to the present invention. Component c) is preferably used in the form of the composite particles defined above. At least one of components b) or c) is in the form of composite particles. Compositions containing component c) as composite particles or containing components b) and c) as composite particles or compositions containing crosslinking agent and crosslinking aid and/or antiaging agent or particles or layers on a carrier are preferred in particular.

Particles and/or layers of any metals and/or any chalcogenides of metals may be used as the particles and/or layers of crosslinking aid and/or antiaging agent adsorbed onto or otherwise attached to the surface of the composite particles used according to the present invention if these particles and/or layers promote the activity of the crosslinking agent and/or resistance to aging processes in the compositions according to the present invention.

It is assumed that the nano-scale particles of crosslinking aid and/or antiaging agent are incorporated only partially into any pores or depressions present on the surface of the carrier particles so that they are freely accessible for the rubber and/or elastomer matrix from the environment of the particle composite.

The crosslinking aids used may include any metals and/or metal chalcogenides using which activation of the crosslinking agent is inducible or which control or catalyze crosslinking.

The antiaging agents may include any metals and/or metal chalcogenides using which it is possible to prevent or retard degradation of the elastomers produced according to the present invention.

Metal oxides are preferred, in particular oxides of magnesium, calcium, barium, titanium, manganese, iron, copper, zinc, silver, gold, platinum, zirconium, yttrium, aluminum, and tin.

Metals of the platinum group, in particular platinum, are also preferred.

Magnesium oxide and/or zinc oxide are preferred in particular.

The crosslinking aids and/or antiaging agents may be present in the form of binary, ternary, and higher systems.

Composite particles are preferably used in which the carrier particle has an average diameter of 5 nm to 50 μm (D₅₀) and in which the particles of crosslinking agent and/or crosslinking aid and/or antiaging agent have an average diameter of 1 nm to 25 μm (D₅₀), in particular 10 nm to 5 μm, most particularly 50 nm to 1 μm, with the provision that the ratio of the average diameter of the carrier particles to the average diameter of the particles of active material is greater than 2:1, preferably between 10:1 and 100:1.

Also preferably used are the composite particles in which the carrier particle has an average diameter of 5 nm to 50 μm (D₅₀) and has a layer of crosslinking agent and/or crosslinking aid and/or antiaging agent having an average layer thickness of 1 nm to 25 μm, in particular 10 nm to 5 μm, most preferably 50 nm to 1 μm, where the ratio of the average diameter of the carrier particle to the average layer thickness of the layer of active material is greater than 2:1, preferably between 10:1 and 100:1.

Other additives which impart a desired property to the elastomer and/or function as processing aids may optionally also be added as component d) to the rubber compounds according to the present invention. Examples of preferred components d) include accelerators, mold release agents, fillers, pigments, flame retardants, antistatics, propellants, plasticizers, biocides, and conventional antiaging agents.

Preferred biocides include copper, silver, gold and compounds thereof, in particular the oxides thereof.

Component d) may be used in a traditional make-up in the compositions according to the present invention. However, it is also possible to use component d) in the form of composite particles that correspond to the composite particles defined above for component b) and/or component c). Composite particles on which components b) and d) or c) and d) or b), c) and d) jointly occur may also be used.

The compositions according to the present invention may be produced according to known methods. Components a), b), c) and optionally d) are usually processed together in mixing equipment. Examples of mixing equipment include kneaders, rolling mills, or extruders. Mixing may be performed as either dry or wet mixing.

Components b) and/or c) used according to the present invention may be produced in various ways.

The components may be produced by mechanical methods, e.g., by joint milling of carrier material and crosslinking aid and/or antiaging agent and subsequent thermal spreading of the crosslinking agent and/or crosslinking aid and/or antiaging agent on the carrier material. In this variant, the nano-scale particles and/or layers are produced directly on the surface of the carrier. Dry coating by high-energy collisions of a powder mixture in a stator/rotor system is another mechanical method.

Furthermore, these components may also be produced by electrostatic charging of the carrier material and nano-scale particles of crosslinking agents and/or crosslinking aids and/or antiaging agent so that supporting of particles is accomplished via Coulomb forces.

It is also possible to produce components b) or c) by pyrogenic gas phase methods and by plasma methods.

Another preferred method for producing composite particles of component b) and/or c) is to coat the carrier material with a suitable thermolabile substance. The layer of thermolabile substance is then treated thermally, so that by decomposing this thermolabile substance while preserving the layer, an increase in surface area of the coated carrier is achieved and then the ultrafine particles and/or layers of crosslinking agent and/or crosslinking aid and/or antiaging agent are applied to the enlarged surface.

Instead of this procedure, the carrier material may be coated with a suitable thermolabile substance and then ultrafine particles and/or thin layers or suitable precursor substances for ultrafine particles and/or thin layers are applied to the surface of the coating by a suitable method. This is followed by a thermal treatment to decompose the thermolabile substance while preserving the layer to increase the surface area and to produce the particles and/or thin layers of crosslinking agent and/or crosslinking aid and/or antiaging agent from the adsorbed substances.

The materials described above may be selected as carrier materials. These carrier materials must be in a fine distribution.

Carrier materials and thermolabile substances are to be selected in the individual case in such a way that the dimensions of the carrier material at the required temperature of the thermal treatment vary by less than 5% or not at all.

Any compounds containing silicon, aluminum, alkaline earth, or alkali and having at least one organic radical, preferably an alkyl radical, which may be partially or completely halogenated, may be used as the thermolabile substances to produce a layer of oxidic material having an irregular surface and sheathing the carrier particles.

Examples of thermolabile substances include silanes or silicon-halogen compounds having at least one organic radical such as aliphatic radicals including ethylenically unsaturated aliphatic radicals, aromatic radicals and/or carboxyl radicals or organoaluminum compounds such as trialkylaluminum, dialkylaluminum halides or alkylaluminum dihalides or organic alkaline earth compounds such as dialkylcalcium or alkylcalcium chloride or organoalkali compounds such as alkyllithium, alkylsodium or alkylpotassium, organic sandwich compounds (metallocenes) or metal carbonyls as well as mixtures thereof.

By a targeted thermal treatment, a layer of oxidic materials characterized by marked fissuring of the surface is produced from the thermolabile substances. In addition to an irregular surface of the carrier particles, which may already exist, this results in an increase in surface area of the particles. This is manifested by an increase in specific surface after thermal treatment of carrier particles coated with the precursor substance.

As a rule, the specific surface (determined according to the B.E.T. method) is increased by at least 10%, preferably by at least 25%, by the thermal treatment. Without being bound to theoretical considerations, it is assumed that pores and/or depressions are formed in the outer layer by decomposition of the organic radicals of the thermolabile substance(s) in such a way that the ultrafine particles and/or the thin layers of crosslinking agent and/or crosslinking aid and/or antiaging agent collect in and/or on these pores and/or depressions. Due to the arrangement of these particles on the surface and/or the use of thin surface layers, it is possible to decrease the active component content while still achieving the desired effects, e.g., catalytic or stabilizing effects.

The term “irregular surface” is understood within the scope of this description to be a surface that deviates from the shape of an ideal spherical surface or the ideal surface of some other rotationally symmetrical shape. Without being bound to theoretical considerations, this may be illustrated on the basis of the following model. If small hemispheres having a radius much smaller than the radius of the large sphere are produced on an entire regular spherical surface, resulting in a surface like a golf ball, then the surface may theoretically be increased to at least 1.8× at a constant radius of the sphere.

The surfaces produced with the material of these preferred components b) and/or c) used according to the present invention are highly fissured, i.e., they have pores and/or depressions, which are formed due to shrinkage of the thermolabile precursor substance (calcination).

The thermolabile substances are applied to the surface of the carrier material by known methods. Examples include impregnation of the surface of the carrier material with the thermolabile substance or a mixture of thermolabile substances or direct application of thermolabile substances to the carrier material by simply mixing the two components. The thickness of the resulting layer is adjustable in a known way via the concentration in the impregnation solution or impregnation suspension and/or emulsion as well as the concentration of surfactants. Typical layer thicknesses of the layer of thermolabile substance on the carrier material are in the range of 1 nm to 1000 nm.

The layer may be formed by equilibrium adsorption. The carrier materials are suspended in a solution, suspension, or emulsion of thermolabile substances and the loading of the carrier materials is controlled via the concentration supplied, the optimum of which is determined from an adsorption isotherm, for example.

Another layer-forming method is known as the “incipient wetness” method, wherein a pasty composition is prepared from the carrier material together with the solution, suspension, or emulsion of the precursor substance of the active phase and the thermolabile substance. Loading is controllable via the amount of thermolabile substance present in the solution, suspension, or emulsion and may be increased by multiple repetitions, if necessary.

The coated carrier material is then dried in air. Typical drying times amount to at least six hours, preferably at least twelve hours. The drying temperature is selected to be between 50° C. and 1 50° C., depending on the thermal stability of the adsorbed substance.

The thermolabile substance may be adsorbed on the surface of the carrier material or may also be covalently bonded to the surface, e.g., by using alkylsilicon-halogen compounds.

The thermolabile substance may advantageously be applied by impregnating the carrier material with a solution in an organic solvent or preferably in water.

The thermal treatment is usually performed in air or under an artificial oxygen-containing atmosphere. The treatment time is to be selected in such a way that it is long enough to produce the enlarged surface phase from the adsorbed thermolabile substances. Typical treatment times amount to more than six hours, preferably more than twelve hours, in particular twelve to twenty-four hours. The choice of temperatures depends on the type of thermolabile material and the atmosphere used. The temperature is to be selected so that the treatment results in at least partial decomposition of the thermolabile substance. The organic radicals usually decompose in the process, forming cavities and fissures in the surface of the layer of thermolabile material. The material of this layer is oxidized at the same time. The layer thus changes but remains a closed layer or a non-closed layer. Typical treatment temperatures vary in the range of 1 50° C. to 500° C.

The progress of the increase in surface area may be tracked by determining the specific surface area of the coated carrier material by essentially known methods. One example of such a method is the determination according to B.E.T. (J. Amer. Chem. Soc., Vol. 60, 309, February 1938).

The thermal treatment surprisingly results in an increase rather than a decrease in surface area. It is assumed that the effect of making the particle surface more uniform, which is induced by the thermal treatment, is overcompensated by partial decomposition of the thermolabile substance.

After thermal treatment of the layer of thermolabile substance or, alternatively, after applying this layer to the carrier material and before thermal treatment of the layer of thermolabile material, the coated carrier material is treated with ultrafine particles and/or precursor substances of ultrafine particles of crosslinking agent and/or crosslinking aid and/or antiaging agent. These particles adhere to the surface of the layer of thermolabile substance or the layer already thermally treated. Instead of applying ultrafine particles, thin surface layers may be produced by applying larger amounts of crosslinking agent and/or crosslinking aid and/or antiaging agent.

The substances described above or their precursors may be selected as crosslinking agents and/or crosslinking aids and/or antiaging agents. Carrier materials, thermolabile substances, and active materials and/or precursors thereof are to be selected in the individual case in such a way that the dimensions of the carrier material and the active material change by less than 5% or not at all at the required temperature of the thermal treatment, and the thermolabile substance and the precursor of the active material do change at the temperature of the thermal treatment. The active material may be produced either simultaneously with or following decomposition of the thermolabile substance.

The active material and/or its precursor may likewise be applied to the surface of the optionally coated carrier material by essentially known methods. Examples include the methods already described in describing the application of the thermolabile substance to the surface of the carrier material, i.e., direct application or impregnation.

Here again, impregnation may be accomplished by application from solution, suspension, or emulsion or by the incipient wetness method.

Examples of impregnation solutions containing precursors of particles or layers of active material include 0.1 M to saturated metal salt solutions, e.g., zinc, magnesium, titanium, calcium, iron, and/or barium salt solutions, the preferred salts being hydroxides, carbonates, carboxylate salts, chlorides, sulfates, acetylacetonates, and/or nitrates. The pH of the impregnation solution is adapted to the particular coated carrier particles used, so that adsorption of the precursor substance on the optionally coated carrier particles is optimized.

The amount of material applied may be adjusted through the concentration of the impregnation solution or impregnation suspension and/or emulsion as well as the surfactants. It is not absolutely necessary to form a closed layer of active material because the ultrafine particles of active material should be deposited on the surface of the carrier material which is optionally coated with organic and/or organosilicon compounds.

The amount of active material, i.e., crosslinking agent and/or crosslinking aid and/or antiaging agent is typically selected so as to yield composite particles having a load of 1 to 50% by weight, preferably 5 to 30% by weight, of active material.

The active material may already be applied in the desired particle shape and distribution to the surface of the optionally coated carrier material, or the ultrafine particles and/or layers of active material may be produced on the surface by a thermal treatment.

Treatment time, composition of the treatment atmosphere, and treatment temperatures are to be selected in such a way that the desired active material is obtained from the corresponding precursor. The adsorbed molecules begin to become mobile and agglomerate on the surface at sufficiently high temperatures. This results in formation of larger and larger supramolecular units which ultimately transition into ultrafine particles or into thin surface layers in the presence of higher concentrations.

The optionally coated carrier material treated with active material and/or its precursor is then dried in air. Typical drying times amount to at least six hours, preferably at least twelve hours. The drying temperature is selected to be between 50° C. and 1 50° C., depending on the thermal stability of the adsorbed substances.

The ultrafine particles and/or layers of active material are usually adsorbed on the surface of the optionally coated carrier material and, depending on the nature and pH of the carrier, via van der Waals interaction (physisorption), via ionic interaction (Coulomb interaction), preferably via covalent bonds (chemisorption, optionally via organic spacer molecules).

The precursor substances for ultrafine particles and/or layers of active material are usually also adsorbed on the surface of the optionally coated carrier material from these precursors. Thermal treatment yields the desired ultrafine particles and/or layers of active material from these precursors. It is assumed that supramolecular units of active material are formed in the process, as already described above. The coverage of the surface of the coated carrier material with active material is controlled by the degree of loading with active phase.

Thermal treatment is usually performed in air or under an artificial oxygen-containing atmosphere. The treatment time should be selected to be long enough to produce ultrafine particles and/or layers of the desired material from the adsorbed precursors of active material.

If the adsorbed substance is a precursor that must be converted to the active phase, the material is thermally treated at the decomposition temperature of the precursor, optionally under a suitable gas atmosphere. The reaction conditions are optimized by those skilled in the art on the basis of routine considerations, using the results of thermal analysis, preferably calorimetry and thermogravimetry.

Typical treatment times amount to more than six hours, preferably more than twelve hours, in particular twelve to twenty-four hours. The choice of temperatures depends on the type of precursor substance and the atmosphere used. The temperature is to be selected so that ultrafine particles and/or layers of active substance are formed by the treatment. Typical treatment temperatures vary in the range from 200° C. to 500° C.

The size range of the particles and/or layers of active material produced from the precursors may be controlled via the amount of precursor substance applied to the surface of the optionally coated carrier particles. Other process parameters include the temperature selected in the individual case and optionally the composition of the atmosphere present in the treatment, e.g., its oxygen concentration and water vapor content.

Using the method described here, particles in the size range of 1 nm to 25 μm or layers having layer thicknesses of up to 25 μm are applied to the surface and/or created on the surface. The particles and/or layers are adsorbed on the surface and fixedly anchored to the carrier below. Due to this fixed attachment, the particles and/or layers of crosslinking aid and/or antiaging agent and/or crosslinking agent cannot agglomerate, so their surface is almost 100% accessible. It is therefore possible to minimize the inaccessible volume amount, which in the case of traditional materials is located in the interior of the particles as a permanent development.

Such materials produced in this way having a typical load of 1 to 50% by weight of the active phase make it possible to greatly decrease the amount and/or consumption of active material due to their extremely fine distribution of the active phase with diameters and/or layer thicknesses down to 1 nm.

Furthermore, the heavy metal content in elastomers may be reduced by a factor of up to ten while the aging properties even under the influence of temperature may also be drastically improved and a high level of mechanical qualities may be achieved that was impossible even with a substantially increased degree of filling using traditional additives.

Use of the supported components b) and/or c) in elastomer compositions is desirable primarily from the standpoint of environmental protection but also in the sense of saving on material and thus sustained development and in the sense of homogeneous materials. In addition, with ultrafine active materials it is possible to achieve effects that are not accessible with traditional active materials because, depending on the concentration, to achieve the mechanical properties, one gets into saturation which is not necessarily applicable to ultrafine additives. In addition, by using the additives according to the present invention, it is possible to formulate systems that permit an increased productivity.

Furthermore, the size dependence of certain effects is not only of a quantitative but also of a qualitative nature; this is an effect known by the term “structure sensitivity” from heterogeneous catalysis. Thus, ultrafine crosslinking agents and/or crosslinking aids and/or antiaging agents are not usually able to manifest their full potential in rubber matrices because they are already in the form of agglomerates or they undergo agglomeration during the mixing operation. The approach for overcoming these problems is to apply the principle of production of heterogeneous catalysts to crosslinking agents and/or crosslinking aids and/or antiaging agents for rubbers and/or elastomers. The ultrafine particles are not applied in the mixing process but instead are applied to larger fillers that are present in rubber and/or elastomer anyway.

The present invention also relates to the use of component c) as defined above as a crosslinking aid and/or antiaging agent for rubbers and/or elastomers.

The present invention also relates to the use of the supported component b) as defined above as a crosslinking agent for elastomers.

The following examples are presented to illustrate the present invention without restricting it.

A 2M zinc acetate solution was adjusted to a pH of 5 and carbon black was impregnated using the incipient wetness method so as to yield a load of 40% by weight ZnO. The resulting paste was dried for at least eight hours at 100° C., then calcined in air at 200° C. for twelve hours and at 250° C. for two hours.

The material was added to a sulfur-crosslinking rubber compound, and corresponding amounts of an originally unmodified carrier material and the traditional zinc oxide (μ scale) originally present in the mixture were removed from the mixture, in such a way that the filler content remained constant but the crosslinking aid and/or ZnO antiaging agent was reduced.

The mechanical values remained at a similar level after 28 days except for the tensile elongation, despite the considerably reduced ZnO content, and the tensile elongation was even 35% better after 28 days. The following table shows the test results of a traditional elastomer and the inventive elastomer described above.

| | | | Inventive |
|---|---|---|---|
| | | | elastomer |
| | Aging time | Standard | mixture |
| | in days of | elastomer | (5 parts |
| | storage at | mixture | ZnO/carbon |
| Tested property | 100° C. | (5 parts μ-ZnO) | black) |
| Microhardness IRHD | 0 | 76 | 78 |
| Microhardness IRHD | 7 | 80 | 81 |
| Microhardness IRHD | 14 | 83 | 83 |
| Microhardness IRHD | 28 | 86 | 86 |
| Tensile strength | 0 | 14.3 | 12.8 |
| (N/mm²) | | | |
| Tensile strength | 7 | 14.9 | 13.5 |
| (N/mm²) | | | |
| Tensile strength | 14 | 15.5 | 13.7 |
| (N/mm²) | | | |
| Tensile strength | 28 | 15.1 | 14.9 |
| (N/mm²) | | | |
| Stress value at | 0 | 3.3 | 3.4 |
| 50% elongation | | | |
| (N/mm²) | | | |
| Stress value at | 7 | 5.5 | 4.7 |
| 50% elongation | | | |
| (N/mm²) | | | |
| Stress value at | 14 | 7 | 6 |
| 50% elongation | | | |
| (N/mm²) | | | |
| Stress value at | 28 | 8.2 | 7.1 |
| 50% elongation | | | |
| (N/mm²) | | | |
| Tensile elongation | 0 | 257 | 217 |
| (%) | | | |
| Tensile elongation | 7 | 176 | 196 |
| (%) | | | |
| Tensile elongation | 14 | 143 | 128 |
| (%) | | | |
| Tensile elongation | 28 | 98 | 134 |
| (%) | | | |

1 to 31. (canceled)

32. A composition comprising:
a) a rubber:
b) a crosslinking agent: and
c) a crosslinking aid and/or antiaging agent, the crosslinking aid and/or antiaging agent being a metal and/or a chalcogenide of a metal;
at least one of components b) or c) being part of composite particles.

33. The composition as recited in claim 32 further comprising carrier particles or conglomerates thereof having a surface, particles of the crosslinking agent having an average diameter of less than 25 μm being applied to the surface, the crosslinking agent and the carrier particles defining crosslinking composite particles.

34. The composition as recited in claim 32 further comprising carrier particles or conglomerates thereof having a surface, particles of the crosslinking aid and/or antiaging agent having an average diameter of less than 25 μm being applied to the surface, the crosslinking aid and/or antiaging agent and carrier particles defining crosslinking aid and/or antiaging composite particles.

35. The composition as recited in claim 32 further comprising additional additives.

36. The composition as recited in claim 32 further comprising carrier particles or conglomerates thereof having a surface, a layer of the crosslinking aid and/or antiaging agent being applied to the surface, the layer having an average layer thickness of less than 25 μm.

37. A composition comprising:
a) a rubber;
b) crosslinking composite particles including carrier particles or a conglomerate thereof having a surface and including a layer of a crosslinking agent having an average layer thickness of less than 25 μm being applied to the surface; and
c) crosslinking aid and/or antiaging composite particles including other carrier particles or another conglomerate thereof having an other surface and including particles of a crosslinking aid and/or antiaging agent being applied to the other surface, the crosslinking aid and/or antiaging agent being a metal and/or a chalcogenide of a metal, the particles of the crosslinking aid and/or antiaging agent having an average diameter of less than 25 μm.

38. The composition as recited in claim 37 further comprising additional additives.

39. A composition, comprising
a) a rubber;
b) crosslinking composite particles including carrier particles or a conglomerate thereof having a surface and including particles of a crosslinking agent being applied to the surface, the particles of the crosslinking agent having an average diameter of less than 25 μm; and
c) crosslinking aid and/or antiaging composite particles including other carrier particles or another conglomerate thereof having an other surface and including a layer of the crosslinking aid and/or antiaging agent being applied to the other surface, the crosslinking aid and/or antiaging agent being a metal and/or a chalcogenide of a metal, the layer having an average layer thickness of less than 25 μm.

40. The composition as recited in claim 39 further comprising additional additives.

41. A composition comprising:
a) a rubber;
b) a crosslinking agent;
c) a crosslinking aid and/or antiaging agent, the crosslinking aid and/or antiaging agent being a metal and/or a chalcogenide of a metal; and
carrier particles or conglomerates thereof having a surface, and particles of the crosslinking agent and crosslinking aid and/or antiaging agent being applied to the surface, particles of the crosslinking agent and the crosslinking aid and/or antiaging agent each having an average diameter of less than 25 μm.

42. The composition as recited in claim 41 further comprising additional additives.

43. The composition as recited in claim 32 wherein the rubber is a synthetic or natural rubber.

44. The composition as recited in claim 43 wherein the synthetic or natural rubber is acrylate rubber, polyester urethane rubber, brominated butyl rubber, polybutadiene. chlorinated butyl rubber, chlorinated polyethylene, epichlorohydrin homopolymer. polychloroprene, sulfonated polyethylene, ethylene-acrylate rubber, ethylene-vinyl acetate rubber, epichlorohydrin copolymer, ethylene-propylene rubber (EP(D)M), sulfur-crosslinked or peroxide-crosslinked, polyether-urethane rubber, ethylene-vinyl acetate copolymer, fluorine rubber (FKM), silicone rubbers, butyl rubber, halobutyl rubber, polyoctenamer, polypentenamer, nitrile rubber, natural rubber, thioplasts, polyfluorophosphazenes, polynorbornene, styrene-butadiene rubber, carboxyl group-containing nitrile rubber or a blend including at least one of the rubbers thereof.

45. The composition as recited in claim 44 wherein silicone rubbers include fluorosilicone rubbers or vinyl-containing dimethylpolysiloxane or hydrogenated nitrile rubber.

46. The composition as recited in claim 32 wherein the rubber is a thermoplastic elastomer.

47. The composition as recited in claim 46 wherein the thermoplastic elastomer are block copolymers or elastomer alloys.

48. The composition as recited in claim 47 wherein the block copolymers are TPE-S, TPE-E, TPE-U or TPE-A.

49. The composition as recited in claim 47 wherein the elastomer alloys are TPE-V or TPE-O.

50. The composition as recited in claim 32 wherein component b) is sulfur, peroxides, bisphenol crosslinking systems, crosslinking resins or compounds acting as crosslinking accelerators.

51. The composition as recited in claim 50 wherein crosslinking resins include polymethylolphenol resins.

52. The composition as recited in claim 50 wherein component b) is thiurams, guanidines, thiazoles, xanthogenates, dithiocarbamates, sulfenamides, dithiophosphates, triazine accelerators or quinone dioximes.

53. The composition as recited in claim 52 wherein component b) is a bisthiocarbamoylsulfane of the general formula: 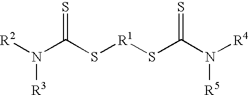
wherein R¹ is a covalent bond or a divalent organic radical, and R² R³ R⁴ and R⁵ independently of one another are hydrogen or organic radicals.

54. The composition as recited in claim 53 wherein R¹ is an alkylene radical.

55. The composition as recited in claim 54 wherein R², R³, R⁴ and R⁵ independently of one another are alkyl or aryl radicals.

56. The composition as recited in claim 32 wherein the composite particles are individual particles or conglomerates thereof, the individual particles including carrier particles sheathed with a layer of oxidic material having an irregular surface, particles of the crosslinking agent and/or crosslinking aid and/or antiaging agent having an average diameter of less than 25 μm being applied to the irregular surface.

57. The composition as recited in claim 32 wherein the carrier particles of component b) and/or c) have an average diameter of less than 5 μm.

58. The composition as recited in claim 32 wherein the carrier particles are carbon, sulfides, sulfates, phosphates, natural fillers, nitrates or pigments.

59. The composition as recited in claim 58 wherein the carrier particles are thermal blacks or flame blacks or oxidic carriers.

60. The composition as recited in claim 58 wherein the carrier particles are precipitated and/or pyrogenic silicas or inorganic carbonates.

61. The composition as recited in claim 58 wherein the carrier particles are bentonites.

62. The composition as recited in claim 32 wherein the crosslinking aid and/or antiaging agent is a metal oxide or a mixture of metal oxides.

63. The composition as recited in claim 62 wherein the metal oxide is selected from a group including the oxides of magnesium, calcium, barium, titanium, manganese, iron, copper, zinc, silver, gold, platinum, zirconium, yttrium, aluminum, and tin.

64. The composition as recited in claim 63 wherein the metal oxide is magnesium oxide and/or zinc oxide.

65. The composition as recited in claim 32 wherein the crosslinking aid and/or antiaging agent is a metal.

66. The composition as recited in claim 65 wherein the metal is a metal of a platinum group.

67. The composition as recited in claim 66 wherein the metal is platinum.

68. The composition as recited in claim 32 wherein the carrier particle has an average diameter of 5 nm to 50 μm (D₅₀), the particles of crosslinking agent and/or crosslinking aid and/or antiaging agent have an average diameter of 1 nm to 25 μm (D₅₀) and a ratio of the average diameter of the carrier particles to the average diameter of the particles of crosslinking agent and/or crosslinking aid and/or antiaging agent is greater than 2:1.

69. The composition as recited in claim 68 wherein the ratio is between 10:1 and 100:1.

70. The composition as recited in claim 32 wherein the composite particles include conglomerates having a plurality of different carrier particles, the different carrier particles having a corpuscular and flaky form and a surface, particles of crosslinking agent and/or antiaging agent and/or crosslinking aid having an average diameter of less 25 μm being applied to the surface and/or a layer of crosslinking agent or antiaging agent and/or crosslinking aid having an average layer thickness of less than 25 μm being applied to the surface.

71. The composition as recited in claim 70 wherein the carrier particles are lamellar carrier particles.

72. The composition as recited in claim 70 wherein the carrier particles are corpuscular quartz and lamellar kaolinite.

73. The composition as recited in claim 70 wherein particles of magnesium oxide and/or zinc oxide having an average diameter of 1 nm to 25 μm are applied to the surface of the different carrier particles or layers of magnesium oxide and/or zinc oxide having an average layer thickness of 1 nm to 25 μm are applied to the surface of the different carrier particles.

74. The composition as recited claim 32 wherein the composite particles b) and/or c) are coated with wax.

75. The composition as recited claim 32 wherein component c) is composite particles or components b) and c) are composite particles.

76. A method for producing an elastomer of the composition as recited in claim 32 comprising the steps of:
i) compounding components a), b), c): and
ii) heating the composition including components a), b), c) to a temperature and for a period of time to induce the crosslinking of component a).

77. The method as recited in claim 76 further comprising compounding additional additives in step i).

78. The method as recited in claim 76 wherein the composition includes additional additives.

79. A method for forming an elastomer comprising the step of:
crosslinking the composition as recited in claim 32.

80. A composite particle for aiding crosslinking in rubbers or antiaging in elastomers comprising:
carrier particles or conglomerates thereof having a surface; and
particles of a crosslinking aid and/or antiaging agent having an average diameter of less than 25 μm applied to the surface or a layer of the crosslinking aid and/or antiaging agent having an average layer thickness of less than 25 μm applied to the surface.

81. A composite particle for crosslinking elastomers comprising:
carrier particles or conglomerates thereof having a surface; and
particles of a crosslinking agent having an average diameter of less than 25 μm applied to the surface or a layer of the crosslinking agent having an average layer thickness of less than 25 μm applied to the surface.
